(19) United States
(12) Patent Application Publication
(10) Pub. No.: US 2016/0026643 A1
(43) Pub. Date: Jan. 28, 2016

(54) PRESENTING SUGGESTED FACETS

(71) Applicant: LinkedIn Corporation, Mountain View, CA (US)

(72) Inventors: Nihit Desai, Mountain View, CA (US); Ashley Woodman Hall, Menlo Park, CA (US); Asif Mansoor Ali Makhani, Fremont, CA (US); Daniel Tunkelang, Mountain View, CA (US)

(21) Appl. No.: 14/339,300

(22) Filed: Jul. 23, 2014

(51) Int. Cl. G06F 17/30

(52) U.S. Cl. CPC G06F 17/3064; G06F 17/30867; G06F 17/3053; G06Q 50/01

(57) ABSTRACT

Method and system to present suggested facets is described. The system includes a search request detector, a search results generator, a facet selector, and a presentation module. The search request detector detects a search request comprising search criteria. The search results generator 220 retrieves search results based on the search criteria. The facet selector selects a suggested facet from a plurality of facets, where a facet represents a category may have a variable value and indicates a filter for refining search results. The presentation module generates a list of items that includes search results and the suggested facet.

### TECHNICAL FIELD

This application relates to the technical fields of software and/or hardware technology and, in one example embodiment, to system and method to present suggested facets to a user in an on-line social network system.

### BACKGROUND

An on-line social network may be viewed as a platform to connect people in virtual space. An on-line social network may be a web-based platform, such as, e,g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to present suggested facets may be implemented;

FIG. 2 is block diagram of a system to present suggested facets, in accordance with one example embodiment;

FIG. 3 is a flow chart of a method to present suggested facets, in accordance with an example embodiment;

FIG. 4 is a diagrammatic representation of an example machine in the form of a computer system within which a set of instructions, for causing the machine to perform any one or more of the methodologies discussed herein, may be executed;

FIG. 5 is an example diagram illustrating presentation of a suggested facet together with search results; and

FIG. 6 is a further example diagram illustrating presentation of a suggested facet together with search results.

### DETAILED DESCRIPTION

A method and system to present suggested facets in an on-line social network is described. In the following description, for purposes of explanation, numerous specific details are set forth in order to provide a thorough understand of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

An on-line social network system may include a search system that permits members to request searches, within the on-line social network, for various information, such as, e.g., jobs postings, people, etc. The searches within the on-line social network may be viewed as navigational (where the intent of the search is to locate a specific item, e.g., a particular person) or exploratory (where the intent of the search is to scan through the available information in order to identify potentially interesting or useful items). While a navigational search may be fairly specific (e.g., indicating the first and last name of a person), an exploratory search may return such a great number of search results that may not be practical for a user to carefully examine all of the items, which may make it difficult to identify those search results that are most useful. A user may wish to refine search by certain criteria, such as a category or a subcategory.

A search system, whether it is a stand-alone system or one integrated with an on-line social network, may include a so-called faceting interface, where the search system presents a user with a set of filters (also termed facets). For example, with respect to searches that have been identified as related to jobs posted in an online network system, facets that may be used to refine search results may include a “company” facet, a “location” facet, etc. A facet may have a variable value. For example, the facet “location” may take specific values corresponding to specific locations, such as, e.g., “San Francisco Bay Area,” “Greater Boston,” etc. A user may be permitted to select a facet and a value from one or more values available for that facet, and initiate a further search that may produce fewer, possibly more focused set of results. Thus, when a faceting interface presents to a user a number of facets with their respective sets of values, the burden is on the user to identify potentially useful facet/value combinations. Furthermore, as a faceting interface may maintain a considerable number of facets, from which a user may make a selection, it may be difficult to present all of the available facets on a screen without requiring a user to scroll or page down in order to view them all. As not all of the available facets may be of interest to a particular user, it may be beneficial to present a user with only those facets that are likely to contribute to the usefulness of the user's search. The usefulness of a refinement of the search results may be ascertained, e.g., by how different is the refined set of search results as compared to the original set of search results. For example, if a search is conducted with respect to jobs in the computer industry and the entire first page of the retrieved search results represents jobs located in San Francisco Bay area, then selecting the facet “location” with the value “San Francisco Bay area” might not produce the results that would be more useful to the originator of the search than the results that have been retrieved in the first place.

Method and system for presenting suggested facets may be provided to aid in more effective searches and in refining search results in a meaningful way. In response to a search request issued by a user, the method and system for presenting suggested facets may present one or more select facets (with their respective select specified values) as search refinement suggestions, rather than exposing the full faceting interface.

In one embodiment, the system for presenting suggested facets utilizes a model (facet suggestion model) that processes information related to a specific search request, examines the available facets and their respective values and, based on the results of the examination, identifies one or more facet/value combinations for presentation to the user as potentially useful search refinement options. In order to select one or more facet/value combinations for presentation to the user, the facet suggestion model may analyze historical information that may be available with respect to the past use of facets. Historical information may include data indicating, which facets are more frequently selected by users to refine their search results, whether the selection of a certain facet is more likely to result in further clicks on the search results than the selection of none or one of the other facets, etc. For example, for a search request related to jobs, the faceting interface may maintain facets such as company, location, job function, industry, experience, time of posting, etc. Historical information with respect to these facets may indicate that users most often select the “location” facet when looking for jobs, and that the selection of the “company” facet results most often in a subsequent click.

The facet suggestion model may also take into account the number of search results returned in response to the initial search request to determine whether to provide suggested facets to the search-originating user. For example, when just one page of search results has been returned in response to the initial search request, any further refinement may not be useful, as the user can easily view all of the available search results.

With respect to some facets, facet selection may be personalized based, e.g., on the information stored in the user's member profile. For example, when the facet suggestion model selects the “location” facet for presentation to a user, the facet suggestion model may access location information specified in the user's member profile and present the “location” facet with the value that matches or is related to the location information specified in the member profile. Other examples of facets that may be personalized include facets related to a user's job function and seniority.

Other factors that may be utilized by the facet suggestion model to select one or more facets for presentation to a user include so called entropy (also termed distribution) with respect to the search results and the values of a certain facet. Entropy, for the purposes of this description, indicates the presence of various values of a facet in the initial search results. High entropy is characterized by the search results set being split evenly among the facet values. Low entropy is characterized by only one value of a facet (or very few values of a large value set of the facet) represented in the search results.

In one embodiment, the facet suggestion model generates a facet score for each facet, based on factors such as historical data with respect to the facets, distribution (or entropy) of the facet values in the search results, and the number of search results returned in response to the original search request.

The facet suggestion model may also calculate a value score for each value of the respective facets. In one embodiment, a value score for a particular value represents the likelihood that the selection of the particular value for the facet would cause significant changes to the initial search results if the facet with that particular value is selected to refine the initial search results. In one embodiment, where a facet lends itself to personalization based on a member profile representing a user who originated the search, the facet suggestion model may only consider those values of a facet that have been determined as relevant to that user. For example, if a user is searching for job postings advertising software engineer positions, and one of the facets available in the search system is related to years of professional experience, the facet suggestion model may only consider a value of that facet that corresponds to the number of years of professional experience indicated in the member profile representing the user.

The facet suggestion model uses the facet scores and the value scores to determine, which facet and which of its value to present to the user. For example, the facet suggestion model may select the highest-scoring facet and its highest-scoring value, or a facet that has the highest scoring value. An example approach for scoring facets and values is described below. The notation for the example approach is shown in Table 1.

TABLE 1

| Variable | Definition | Example |
|---|---|---|
| F | set of facets | {location, network, |
| | | seniority} |
| f | a facet that belongs to F | location |
| V(f) | set of facet values for a | V(location) = {SF Bay |
| | given facet f | Area, NYC Area} |
| v | A facet value that belongs | SF Bay Area |
| | to V(f) | |

The process of scoring facet values v∈V(f) for a given facet f uses the following signals:
Popularity—the number of times a facet value was applied as a fraction of the no. of times it was shown (inferred from offline analysis);
Personalization—an indication of whether the facet value can be personalized for the user (e.g., inferred from the user's profile information);
Coverage—the fraction of the original result set that will remain if a facet refinement is applied using this facet value (e.g., inferred by computing facet counts from the entire result set, for each facet value);
Diversity—the fraction of the top page of results that will change if a facet refinement is applied using this facet value (inferred by computing facet counts from the top page result set, for each facet value).

Example equation for calculation a value score Score(v) is shown below.

Score(v)=Popularity(v)*Personalization(v)α* [β*Coverage(v)+(1β)*Diversity(v)],

where:

α=parameter with binary value (0 or 1) depending on whether personalization matters for the given facet, and

β=parameter in the range of [0,1] which controls the relative weights of coverage and diversity. In our current implementation we set this value to 0.5.

The value expressed by “Popularity(v)*Personalization(v)^{α}” is indicative of how likely is the user to select the facet v. The values expressed by “[β*Coverage(v)+(1−β)*Diversity(v)]” is indicative of how useful will it be to the user if he/she should choose to select the facet value v.

The process of scoring facets f∈F uses the popularity value—the number of times a facet was applied as a fraction of the number of times it was displayed (e.g., inferred from offline analysis). In some embodiments, instead of always selecting the facet with maximum score, the selection of a facet may be randomized by inferring Popularity(f) as the probability of that facet being selected. If all facets have some non-zero probability of being selected, the facets that are used more often are suggested more frequently and the facet suggestions are diverse (instead of showing the same suggestion to the user every time).

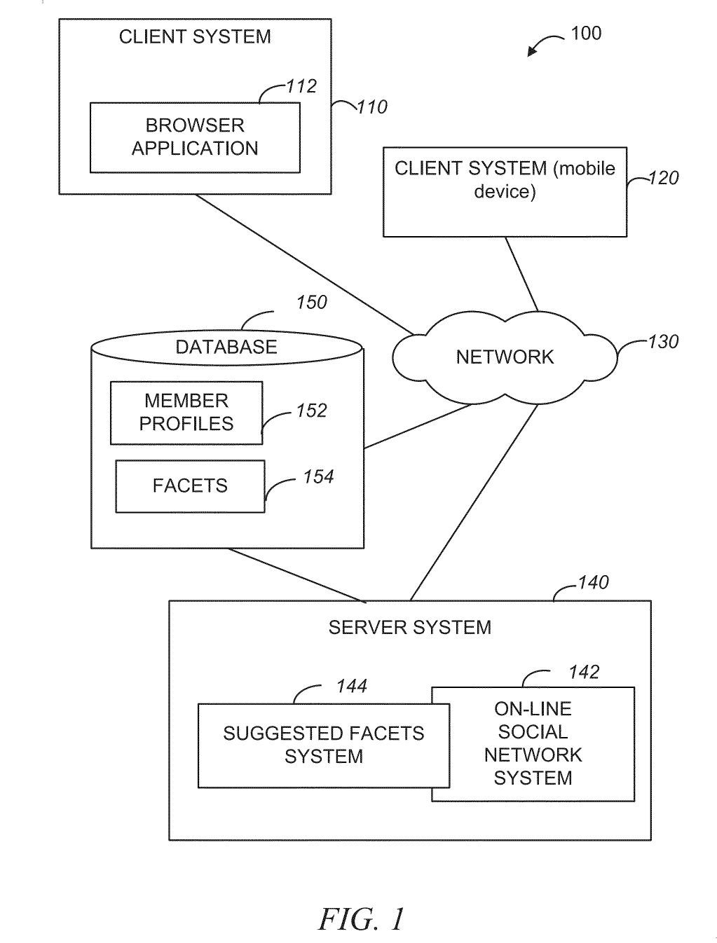

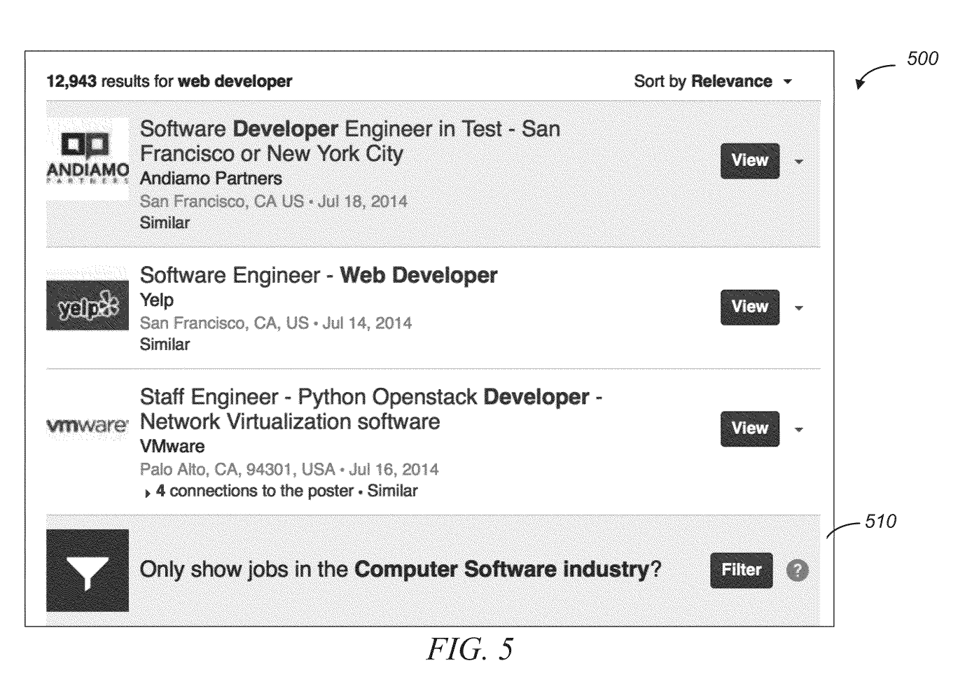

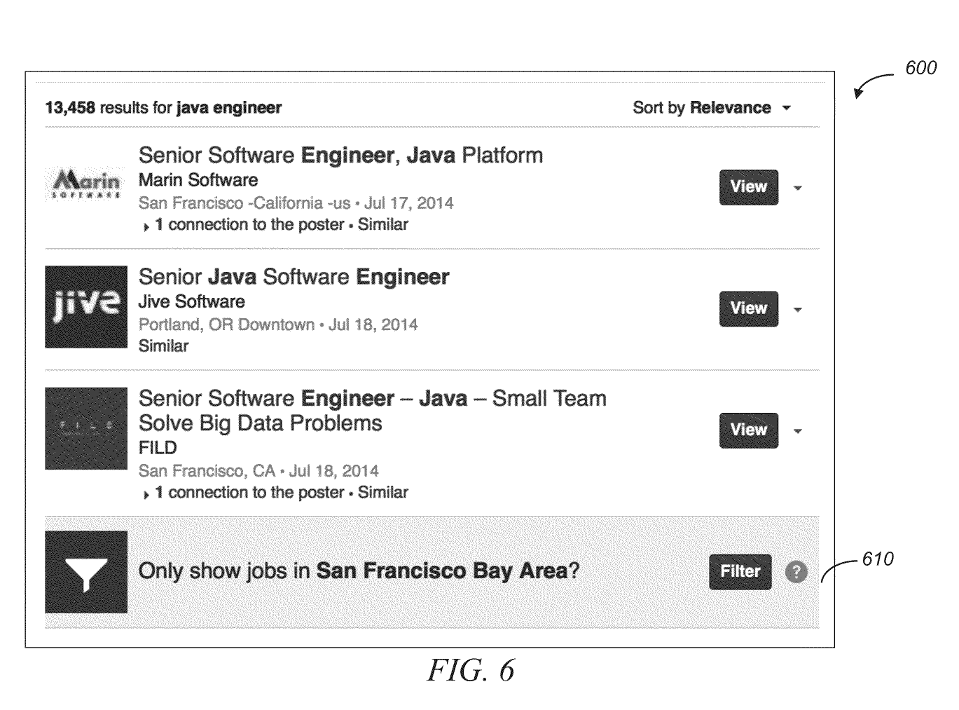

A facet/value suggestion may be presented to the user in the same list as the initial search results. The facet/value suggestion may appear as the first item in the search results, as the last item on the first page of the search results, etc. The diagram 500 shown in FIG. 5 illustrates presentation of an industry-related facet with its value set to “Computer Software” presented in area 510. The diagram 600 shown in FIG. 6 illustrates presentation of a location-related facet with its value set to “San Francisco Bay Area” presented in area 610. Example method and system to present suggested facets to a user may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 may also store facets 154. As explained above, facets may be utilized as filters for refining search results, e.g., search results retrieved in response to a search request within an on-line social network system.

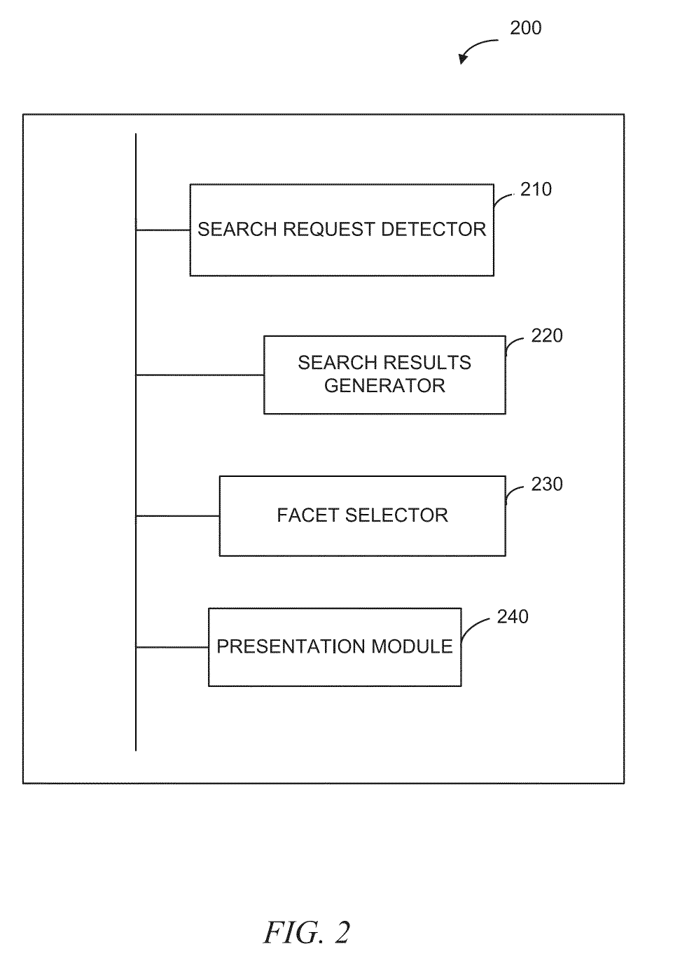

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a suggested facets system 144 that may be utilized beneficially to aid users in refining search results provided in the on-line social network system 142. The suggested facets system 144 may be configured to determine, which facet and which value of the facet may be useful in refining search results and present the facet and the value to the user together with the initial search results. As mentioned above, in order to make a determination, which facet is predicted to be most useful to the user who originated the initial search, the suggested facets system 144 may use a facet suggestion model that generates a facet score for each facet and value scored for at least some of the values of at least some of the facets. The facet scores may be calculated based on factors such as historical data with respect to the facets, distribution (or entropy) of the facet values in the search results, and the number of search results returned in response to the original search request. The value scores may be generated based on the distribution of the value in the search results, as well as based on information retrieved from the user's member profile, etc. An example suggested facets system 144 is illustrated in FIG. 2.

FIG. 2 is a block diagram of a system 200 to present suggested facets, in accordance with one example embodiment. As shown in FIG. 2, the system 200 includes a search request detector 210, a search results generator 220, a facet selector 230, and a presentation module 240. The search request detector 210 may be configured to detect, in the on-line social network system 142 of FIG. 1, search requests comprising search criteria. The search results generator 220 may be configured to retrieve search results based on the search criteria. The facet selector 230 may be configured to select a suggested facet from a plurality of facets. The plurality of facets may be maintained in in an on-line social network system. A facet represents a category and may have a variable value. For the purposes of this description, a facet indicates a filter for refining search results in the on-line social network. The presentation module 240 may be configured to generate a list of items for presentation at a client computer, and include the suggested facet into the list of items.

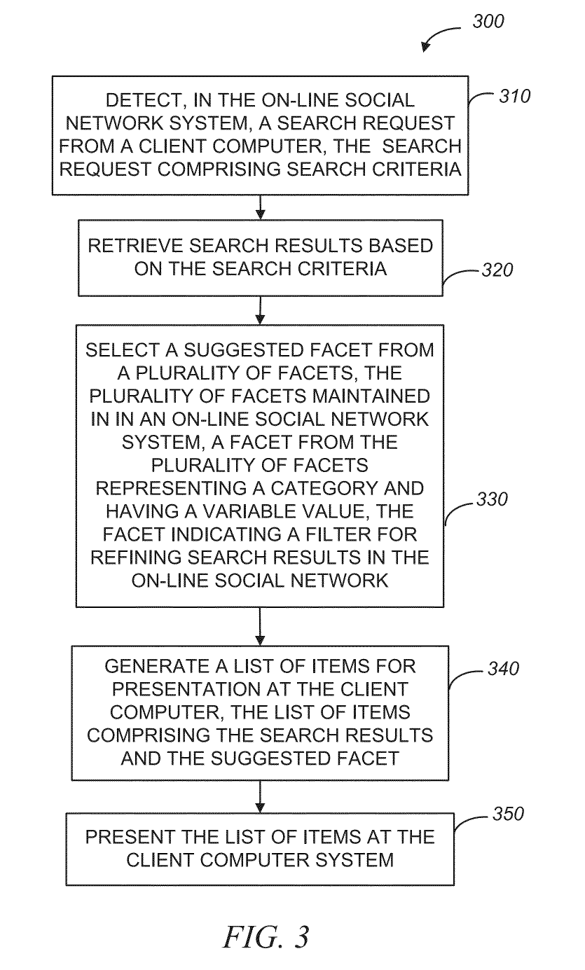

In one embodiment, the facet selector 230 may be configured to calculate respective facet scores for facets and value scores for various values associated with respective facets. The facet scores and the value scores may be used by the facet selector 230 to determine, which facet/value combination is to be suggested to a user. The facet scores may be generated using historical data with respect to the facets (e.g., respective frequencies of use for the facets over a period of time, data that indicates respective frequencies of subsequent clicks occurrences for the facets, etc.), respective entropy values associated with different values of facets, as well as a number of the retrieved search results retrieved in response to the initial search request. The facet selector 230 may be configured to select the suggested facet in response to determining that the number of the retrieved search results is equal or greater than a predetermined threshold value The entropy determined for a particular value of a facet indicates the frequency of occurrence of that value in the retrieved search results. In one embodiment, the facet selector 230 may utilize a facet suggestion model that processes information related to a specific search request, examines the available facets and their respective values and, based on the results of the examination, identifies one or more facet/value combinations for presentation to the user as potentially useful search refinement options. Some operations performed by the system 200 may be described with reference to FIG. 3.

FIG. 3 is a flow chart of a method 300 to present suggested facets to a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the search request detector 210 of FIG. 2 detects a request from a client computer. At operation 220, the search results generator 220 of FIG. 2 retrieves search results based on the search criteria included with the search request. The facet selector 230 of FIG. 2 selects a suggested facet from a plurality of facets at operation 230. At operation 240, the presentation module 240 of FIG. 2 generates a list of items that includes search results together with the suggested facet. At operation 350, the list of items is presented at the client computer.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines, In some example embodiments, the processor or processors may be located in a single location (e.g., within a home environment, an office environment or as a server farm), while in other embodiments the processors may be distributed across a number of locations.

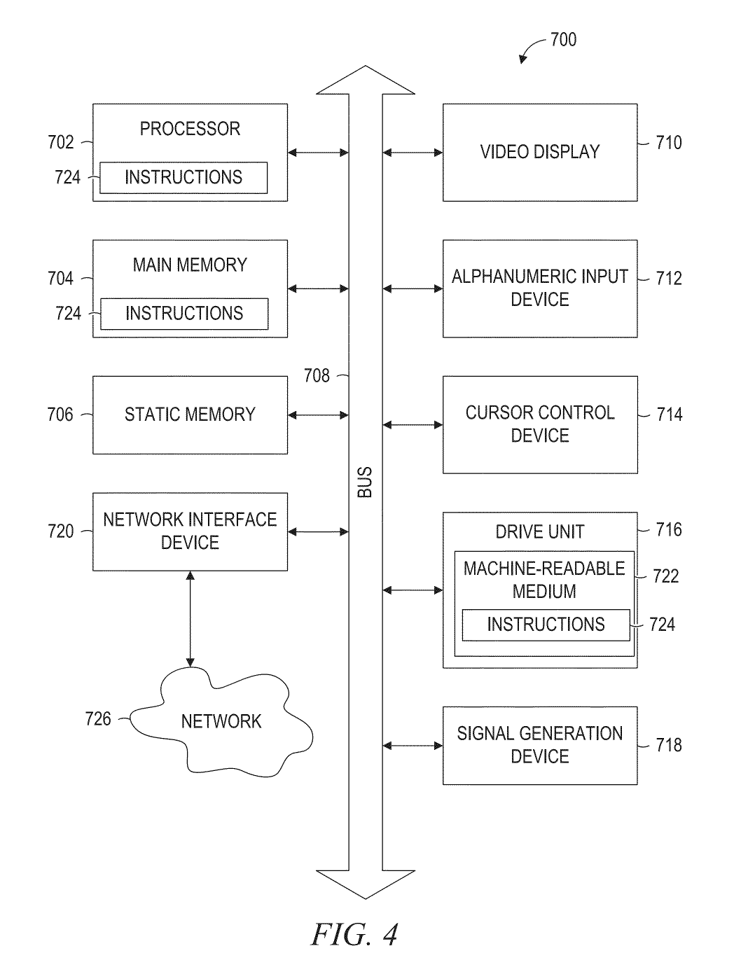

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e,g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components And Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e,g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to present suggested facets have been described. While the techniques for presenting suggested facets have been described with reference to searches in the context of an on-line social network system, the, method and system to present suggested facets may be used beneficially in any context where electronic search results are being requested and retrieved. Although embodiments have been described with reference to specific example embodiments, it will be evident that various modifications and changes may be made to these emodiments without departing from the broader scope of the inventive subject matter. Accordingly, the specification and drawings are to be regarded in an illustrative rather than a restrictive sense.

1. A computer-implemented method comprising:
detecting, using at least one processor, in the on-line social network system, a search request from a client computer, the search request comprising search criteria;
retrieving search results based on the search criteria;
selecting, using at least one processor, a suggested facet from a plurality of facets, the plurality of facets maintained in in an on-line social network system, a facet from the plurality of facets representing a category and having a variable value, the facet indicating a filter for refining search results in the on-line social network; and
generating a list of items for presentation at the client computer, the list of items comprising the search results and the suggested facet.

2. The method of claim 1, comprising calculating respective facet scores for facets from the plurality of facets, wherein the selecting comprises utilizing the facet scores.

3. The method of claim 2, wherein the calculating of the respective scores comprises utilizing historical data with respect to the facets.

4. The method of claim 3, wherein the historical data comprises respective frequencies of use for the facets over a period of time.

5. The method of claim 3, wherein the historical data indicates respective frequencies of subsequent clicks occurrences for the facets.

6. The method of claim 2, wherein the calculating of the respective value scores comprises determining entropy for a value from values associated with a facet from the facets, the entropy indicating frequency of occurrence of the value in the retrieved search results.

7. The method of claim 2, wherein the calculating of the respective scores comprises utilizing a number of the retrieved search results.

8. The method of claim 7, wherein the selecting of the suggested facet is in response to determining that the number of the retrieved search results is equal or greater than a predetermined threshold value.

9. The method of claim 1, comprising calculating respective value scores for values associated with the facets, wherein the selecting comprises utilizing the value scores.

10. The method of claim 1, wherein the generating of the list of items for presentation at the client computer comprises determining a position of the suggested facets in the list of items.

11. A computer-implemented system comprising:
a search request detector, implemented using at least one processor, to detect, in the on-line social network system, a search request from a client compute the search request comprising search criteria;
a search results generator, implemented using at least one processor, to retrieve search results based on the search criteria;
a facet selector, implemented using at least one processor, to select a suggested facet from a plurality of facets, the plurality of facets maintained in in an on-line social network system, a facet from the plurality of facets representing a category and having a variable value, the facet indicating a filter for refining search results in the on-line social network; and
a presentation module, implemented using at least one processor, to generate a list of items for presentation at the client computer, the list of items comprising the search results and the suggested facet.

12. The system of claim 11, wherein the facet selector is to calculate respective facet scores for facets from the plurality of facets and to utilize the respective facet scores to select the suggested facet.

13. The system of claim 12, wherein the facet selector is to calculate the respective facet scores utilizing historical data with respect to the facets.

14. The system of claim 13, wherein the historical data comprises respective frequencies of use for the facets over a period of time.

15. The system of claim 13, wherein the historical data indicates respective frequencies of subsequent clicks occurrences for the facets.

16. The system of claim 12, wherein the facet selector is to determine entropy for a value from values associated with a facet from the facets to calculate the respective facet scores, the entropy indicating frequency of occurrence of the value in the retrieved search results.

17. The system of claim 12, wherein the facet selector is to calculate the respective facet scores utilizing a number of the retrieved search results.

18. The system of claim 17, wherein the facet selector is to select the suggested facet in response to determining that the number of the retrieved search results is equal or greater than a predetermined threshold value.

19. The system of claim 11, wherein the facet selector is to calculate respective value scores for values associated with the facets, and to utilize the respective value scores to select the suggested facet.

20. A machine-readable non-transitory storage medium having instruction data to cause a machine to perform operations comprising:
detecting, in the on-line social network system, a search request from a client computer, the search request comprising search criteria;
retrieving search results based on the search criteria;
selecting a suggested facet from a plurality of facets, the plurality of facets maintained in in an on-line social network system, a facet from the plurality of facets representing a category and having a variable value, the facet indicating a filter for refining search results in the on-line social network; and
generating a list of items for presentation at the client computer, the list of items comprising the search results and the suggested facet.
